(19) United States
(12) Patent Application Publication
(10) Pub. No.: US 2004/0139652 A1
(43) Pub. Date: Jul. 22, 2004

(54) Abutilon and Cicer for use as a refuge for lepidoptera in transgenic crops

(76) Inventor: Carlos A. Blanco, Greenville, MS (US)

Correspondence Address: DOW AGROSCIENCES LLC, 9330 ZIONSVILLE RD, INDIANAPOLIS, IN, 46268, US

(21) Appl. No.: 10/754,420

(22) Filed: Jan. 9, 2004

Related U.S. Application Data
(60) Provisional application No. 60/439,336, filed on Jan. 10, 2003.

(51) Int. Cl. A01B 79/02

(52) U.S. Cl. 47/58.1 R

(57) ABSTRACT

The invention is drawn to a method for creating refugia for insects susceptible to Bacillus thuringiensis (Bt) toxins to prevent or delay the onset of insect population resistant to Bt toxins. The method involves interplanting velvetleaf (Abutilon) and/or garbanzo beans (Cicer) in a Bt crop of choice.

### BACKGROUND OF THE INVENTION

Velvetleaf (Abutilon theophrasti Medikus), a plant considered a weed in cotton fields, is well known for its susceptibility to Heliothis and Helicoverpa attack (Hendricks 1992, Schneider et al. 1989, Navasero and Ramaswamy 1991). It has also been observed that whiteflies (Headrick et al. 1997) and a scentless plant bug (Patterson et al. 1987, Spencer 1988) are attracted to this plant. Garbanzo beans (also known as chickpeas. Cicer arietinum L.) is an important agronomic crop in several parts of the world and is known to have few insects that feed on it. Heliothis spp. are the most prominent pests reported to infest garbanzo beans (Shaver and Lopez 1996, Reed et al. 1980) and Helicoverpa armigera (Hübner) (Ramnath et al. 1992); though, armyworms (primarily Spodoptera exigua (Hübner)) have been known to defoliate garbanzo beans in Mexico and the US.

Refugia is the term used to describe a vegetative area where a population of susceptible insects live in the vicinity of transgenic crops bearing recombinant genes which express toxic Bacillus thuringiensis (Bt) proteins. One of the biggest concerns with Bt crops is that their wide spread use will lead to selection of insects resistant to Bt toxins. Maintaining a population of susceptible insects via the use of refugia is thought to be one way to reduce the development of insect resistance to Bt toxins.

It is believed that maintaining a population of susceptible insects will prevent widespread resistant phenotypes from developing. For example, if two Bt resistant insects mate, all of their offspring will be resistant which could start a resistant biotype. However, if these two resistant individuals mate with some susceptible insects, then the offspring will only carry one gene for resistance and may not be able to survive feeding on a Bt crop.

The refuge strategy depends on susceptible insects mating with resistant individuals before the resistant ones have a chance to mate with on another. Four factors are critical to the refuge strategy: 1) the size of the refuge, 2) its distance from the resistant insects, 3) that resistant and susceptible insects occur at the same time, and 4) the number or ratio of susceptible to resistant insects. Estimates on the refuge size needed to maintain enough insects to effectively slow the development of resistance vary greatly. Entomological modeling has suggested adequate refuge areas from five to fifty percent of the Bt crop acreage, depending on how heavy the insect infestation is and on whether the refuge is treated with chemical insecticides. Several methods for deploying refuge have been proposed, all of which rely on planting non-Bt versions of the crop. The ratio of susceptible to resistant insects to prevent intermingling of resistant insects has been theoretically estimated to be 500:1.

One method would be to use a mixture of a Bt and non-Bt crop. However, this method is thought to be unsatisfactory because there is a chance that immature larvae could move from susceptible plants to Bt plants. Larger larvae have been reported to have an inherent ability to survive on higher concentrations of Bt than smaller larvae. Therefore this refuge model could increase the chance of susceptible individuals mating with Bt resistant insects.

Another method is to inter-plant one or two rows of the non-Bt crop throughout the field. This method has its drawbacks should insect infestation be heavy enough to require chemical insecticide application of the refuge.

Another method is to plant strips of non-Bt crop among the Bt crop. This will theoretically allow for spraying the non-Bt crop should insect infestations be heavy. This however is difficult in practice because planting in this manner will require the farmer to clean out the planter and change seed more often and make it more difficult to remember where the non-Bt strips were planted. Also the large number of susceptible to resistant insects (500:1) requires large numbers of insects to be produced in the refugia.

The last method is to plant fields of Bt crop next to fields of non-Bt crop which is operationally much easier but riskier because it increases the distance that susceptible insects need to travel to find resistant insects.

Thus, there exists a need for other facile methods for deploying refugia that effectively limit the rate at which resistant insect populations emerge.

### SUMMARY OF THE INVENTION

The invention encompasses a method for creating refugia near a transgenic Bt crop comprising interplanting plants chosen from the group consisting of Abutilon and Cicer in the Bt crop.

### DETAILED DESCRIPTION OF THE INVENTION

In its broadest form, the invention provides a method for creating a refugia for insects that are susceptible to Bt toxins. Bt toxins originated from the spore forming gram-positive bacterium Bacillus thuringiensis that produces a parasporal crystal composed of crystal proteins. Many different crystal proteins, toxic to a variety of insect genera, have been described and are well known in the scientific literature. See for example Schnepf, et al., Microbiology and Molecular Reviews, September 1998, pp. 775-806. In addition a growing number of Bt crops including commercially important crops such as corn, cotton, canola and potatoes are now available and widely used. This invention is consistent with creating refugia for all types of Bt crops but is preferably applicable for Bt cotton.

There are numerous species within the genera Abutilon and Cicer, all of which are consistent with the present invention. In more humid environments, species within the genus Abutilon are preferred while in less humid climates species within the genus Cicer are preferred. The most preferred plant within the genus Cicer is Cicer arietinum L. Moreover, the invention also contemplates employing a mixture of plants within either or both Abutilon and Cicer.

For purposes of this specification interplanting is defined as any pattern of placing refugia plants in or near the Bt crop. This is meant to include interplanting plant by plant, row by row, strips within the field, or plots near the Bt field, or any combination of the foregoing. A preferred pattern consists of interplanting rows of refugia plants in the Bt crop of choice. Using marginal areas, such as those commonly used to place refugia for Bt cotton under current US regulations, is an ideal place for refugia plants and is most preferred for purposes of this invention. Interplanting to relieve pest pressure on the non Bt crop is also important for a yield standpoint in the refugia.

Following are examples illustrating procedures for practicing the invention. These examples should not be construed to be limiting; but should include obvious variations.

### EXAMPLE 1

### Cotton Interplanted with Velvetleaf and/or Garbanzo Beans

Cotton (Gossypium hirsutum L) variety DP436RR (glyphosate-resistant) grown on sandy loam soil in a research farm in Waller, Tex. was maintained under normal local agronomic conditions to conduct Tests 1-3. In both years (2000 and 2001), study fields consisting of 60 rows (40-inch row centers) by 132 feet in length, with a 20-foot space between replications 2 and 3, and actual plots of 25 feet long replicated four times, received a split application of fertilizer (4-11-11 ground incorporated at planting on both years) and a foliar application (32-0-0) 40 d later in 2000 only. Aldicarb at 1.19 lb ai/A was incorporated at planting both years.

Test 1. In 2000, two cotton fields separated by 66 feet were used to compare the influence of velvetleaf interplanted with cotton on the incidence of tobacco budworm (TBW), Heliothis virescens (F.). The interplanted field was seeded with velvetleaf the same day of cotton planting (131 day of year [DOY]), obtaining an average stand of 0.15 plants per row-foot, while the cotton plant density in both fields was 2.25 plants/ft. Velvetleaf seed was obtained from a commercial distributor. The rest of the plants not involved in this study (weeds) in the interplanted field were removed by hand, except carpetweed (Mollugo verticillata L.) due to the difficulty of controlling it by this method. In the field with cotton only, weed control was achieved with one application of glyphosate at 0.75 lb ai/A. Evaluations were made by removing and inspecting 50 randomly selected cotton plants per field at different dates to determine TBW population levels in both treatments, recording also the number of fruiting structures per plant and the weight of the lowest boll before opening (Day of Year (DOY) 216). A paired t-test was used to analyze for the differences.

In this test, a significantly higher number of tobacco budworm larvae on cotton interplanted with velvetleaf than on cotton grown as monoculture was observed on only one date (Table 1). On DOY 193, interplanted cotton had numbers of larvae per plant above the economic threshold recommended in Texas (>5,000 larvae per acre). The higher number of budworms in interplanted cotton might also be reflected in the higher number of damaged squares, terminals and bolls found on the different evaluation dates.

TABLE 1
Mean plant damage and tobacco budworm
(Heliothis virescens) incidence per 50 cotton plants
grown as monoculture and interplanted with velvetleaf.

| | Cotton | Cotton + Velvetleaf |
|---|---|---|
| Day of year | | |
| 158 (DOY) | | |
| Eggs | 13 | 18 |
| Larvae | 4 | 7 |
| Damaged squares | 9 | 13 |
| Damaged terminals | 6 | 8 |
| DOY 172 | | |
| Eggs | 3 | 7 |
| Larvae | 1 | 4 |
| Damaged squares | 11 | 21 |
| Damaged terminals | 12 | 14 |
| DOY 193 | | |
| Eggs | 0 | 1 |
| Larvae | 2* | 16* |
| Damaged squares | 18* | 68* |
| Damaged terminals | 2 | 7 |
| Damaged bolls | 11* | 25* |
| DOY 205 | | |
| Larvae | 0 | 1 |
| Damaged squares | 6 | 5 |
| Damaged terminals | 8 | 14 |
| Damaged bolls | 1* | 8* |
| Weight of 50 bolls (grams) | 745 | 779 |

*Significantly different at α = 0.05 by T-test.

Test 2. A field in 2001, planted on DOY 113, was interplanted with velvetleaf and garbanzo beans at a density of 1.27 and 1.39 plants per row-foot, respectively, with a cotton plant density of 2.25 plants/ft. On DOY 159, when the cotton plants had achieved 5^{th}-true leaf stage, glyphosate herbicide (0.75 lb ai/A) was broadcast to control all the plants in one of every 3 rows, leaving a pure stand of cotton. Garbanzo bean seed was obtained from a commercial source. On DOY 171 (pre-blooming, 12^{th} internode), one of every two of the untreated interplanted rows was treated with glyphosate (post-directed application) again in order to kill the established plants, except cotton. Velvetleaf was hand weeded due to its height, and pulled plants were left within the rows. What remained was a row of cotton and dying plants that later will be called “late weed control” in the text. The rows maintained as a pure cotton stand are referred to as “monoculture” and the rows without weed control are called “interplanted” in this study. The plants on the rows treated on DOY 171 were killed in order to “force” the insect population established on velvetleaf and garbanzo beans to disperse into the cotton plants. The interplanted rows contained an infestation of carpetweed plants at the time that the evaluations were made, but no pests of interest were found on these. Ten randomly selected cotton plants per replication on each of the three treatments were removed and inspected (data not included), as well as sweeping with a net (15.3″ diameter) 100 times for each sample on different rows per treatment per replication. Data were analyzed by analysis of variance (ANOVA) and when F-values were significant (P<0.05), means were separated using Tukey's test with α=0.05.

Results of this test, planned to find a way to “force” the larvae feeding on velvetleaf or garbanzo beans to feed on cotton plants, can be divided into 2 major parts: The first part relates to insect numbers before they were “forced” to move into cotton. Data shown on evaluation DOY 169 (Table 2) compare one row of cotton grown as monoculture with 2 rows interplanted with the above mentioned plants (late weed control and interplanted). Although not all the densities of insect species were significantly different among these 2 plant diversity scenarios, greater numbers of budworms and beet armyworms (Spodoptera exigua Hübner) were present on interplanted cotton rows. Since this evaluation was made with a sweep net, only those larvae from the monoculture rows can be said to have come from cotton plants alone. It is well known that velvetleaf attracts tobacco budworms, but we were not able to find beet armyworms feeding on this plant either in this study or in study Test 3. Therefore, beet armyworms must have come only from cotton, since garbanzo beans were not swept due to their low height. The second part relates to insect numbers after they were “forced” to move to cotton. Although the population of some species was high when we initiated this test, numbers greatly diminished throughout the test. The beet armyworm population crashed making it impossible to find out if these insects were susceptible to switch from garbanzo beans to cotton. The saltmarsh caterpillars, Estigmene acrea Drury, although also declining in numbers, did not show any indication of increasing their numbers on cotton. This might be due in part to the fact that these insects were found already on cotton plants and very few on the other 2 plant species. Cabbage loopers, Trichoplusia ni Hübner, demonstrated a “switch” from velvetleaf and garbanzo beans to cotton. These insects were found mostly on velvetleaf on previous evaluations, and after this plant was pulled from interplanted rows (late weed control), some of those insects were swept from cotton plants on DOY 177. Higher numbers of cabbage loopers were obtained from the interplanted rows because these plants were swept together with cotton. The switch of tobacco budworm from velvetleaf and garbanzo beans to cotton is more difficult to document and explain. At the moment of the initiation of the test, large numbers of this insect were found, but they were at an advanced larval stage (≧third instar). If they really made the change from the preferred plants to cotton, they must have moved to feed on large cotton squares and bolls due to their feeding habits. Since these fruiting structures were lower in the cotton canopy at the time of the evaluation, sweeps with the net might have missed them; therefore, capturing low numbers of budworns and not offering a clear picture of their behavior. In addition, since these insects feed on flowers and seeds of velvetleaf and these plants were swept while evaluating the interplanted rows, many tobacco budworms were captured by this method. We believe the majority of them came from velvetleaf. In this test, we were able to see only a clear “switch” of the cabbage looper from alternative plants into cotton.

TABLE 2
Mean number of larvae per 100 sweeps on cotton plants
grown under different plant diversity.

| | | | |
|---|---|---|---|
| TBW^{a} | SMC^{a} | CL^{a} | BAW^{a} |

Larvae on DOY 169

| | | | | |
|---|---|---|---|---|
| Monoculture | 1.0 b | 9 | 0.0 b | 22 |
| Late weed control | 14.3 a | 11 | 1.0 b | 83 |
| Intercropping | 13.5 a | 9 | 3.0 a | 85.3 |
| Larvae on DOY 177 | | | | |
| Monoculture | 0.3 | 2 | 0.0 b | 0 |
| Late weed control | 5.3 | 10 | 12.0 a | 0 |
| Intercropping | 7.3 | 12 | 13.0 a | 0 |
| Larvae on DOY 186 | | | | |
| Monoculture | 0.5 | 0 | 1.0 b | 0 |
| Late weed control | 0.0 | 3 | 0.0 b | 0 |
| Intercropping | 1.8 | 2 | 6.0 a | 0 |

^{a}TBW = tobacco budworm, SMC = saltmarsh caterpillar, CL = cabbage looper, BAW = beet armyworm. Means by column in each DOY followed by a different letter are significantly different at α = 0.05.

Test 3. A field in 2001 was planted and interplanted with velvetleaf and garbanzo beans on DOY 113, obtaining a final density of 1.27 and 1.39 plants per row-foot, respectively, and a cotton density of 2.25 plants/ft. The field was divided into 6 plots of 6 rows each 25 feet long and replicated 4 times. Treatments described on Table 3 were arranged in a randomized complete block design. In order to achieve the plant diversity necessary for this test, plots were hand-weeded on DOY 141, 148 and 159. All the plots had an infestation of carpetweed not controlled by hand weeding. Evaluations in this test were made by removing 10 cotton plants per plot and inspecting them for insect presence and damage. Cotton yields were obtained by hand harvesting rows 3 and 4 per plot on DOY 261. Data were analyzed by analysis of variance (ANOVA) and when F-values were significant (P<0.05), means were separated using Tukey's test (α=0.05).

Determining the effect of interplanting velvetleaf and/or garbanzo beans on insect numbers on cotton plants was the main objective of this test. Results shown on Table 3 describe the numbers of larvae present on cotton plants at the time of the evaluations, and these data can be divided by insect species: a) Tobacco budworms had the tendency for higher numbers on cotton plants mixed with garbanzo beans, although not significantly different on all the evaluation dates. Cotton with velvetleaf did not show this pattern. This suggests that garbanzo plants have a greater potential to bring tobacco budworms into research plots than velvetleaf. b) Beet armyworms also showed a higher preference for plots interplanted with garbanzo beans. These armyworms, although not found on velvetleaf while making individual plant inspections, induced heavy defoliation on garbanzo beans in this study, supporting the finding that cotton interplanted with garbanzo could be more “attractive” to the beet armyworm. c) Cabbage loopers were higher on cotton plants interplanted with velvetleaf than those cotton plants grown alone or with garbanzo beans. This insect was observed feeding on velvetleaf while doing individual plant inspections. d) The saltmarsh caterpillar did not show any preference for the addition of any alternative plant to the research plots, except on one evaluation date (DOY 191) when in one replication a recently hatched egg mass was found on one cotton plant, making those numbers higher than what they were observed throughout the field.

The major findings of this test were the preference of the tobacco budworm and the beet armyworm for those cotton plants grown together with garbanzo beans and the cabbage looper preference for those cotton plants interplanted with velvetleaf. In addition, by analyzing the yield results, it can be observed that the presence of garbanzo beans in the plots did not significantly affect yield as compared to velvetleaf. The number of squares and bolls in all the treatments were not significantly different (data not included), therefore, the significant difference in yield between interplanting garbanzo beans or velvetleaf with cotton might be explained by the plant competition between velvetleaf and cotton or the added nitrogen fixed by garbanzo beans. This last consideration is also important in selecting one of these plants to interplant with cotton.

TABLE 3
Mean number of larvae per cotton plant grown
under different plant diversity and seed cotton yield.

| | | | |
|---|---|---|---|
| TBW^{a} | BAW^{a} | CL^{a} | SMC^{a} |

Larvae per plant on DOY 156

| | | | | |
|---|---|---|---|---|
| Cotton | 0.13 | 0.87 c | 0.00 b | 0.00 |
| Cotton + Velvetleaf | 0.00 | 0.65 c | 0.00 b | 0.00 |
| Cotton + Garbanzo | 0.68 | 10.37 a | 0.30 a | 0.00 |
| Cotton + Velvetleaf+ Garbanzo | 0.50 | 6.92 b | 0.15 ab | 0.00 |
| Larvae on DOY 165 | | | | |
| Cotton | 0.00 c | 0.00 b | 0.00 | 0.40 |
| Cotton + Velvetleaf | 0.33 bc | 0.00 b | 0.00 | 0.50 |
| Cotton + Garbanzo | 0.60 ab | 0.87 a | 0.00 | 0.42 |
| Cotton + Velvetleaf + Garbanzo | 0.75 a | 0.95 a | 0.15 | 0.15 |
| Larvae on DOY 169 | | | | |
| Cotton | 0.00 | 0.3 | 0.00 | 0.10 |
| Cotton + Velvetleaf | 0.00 | 0.0 | 0.30 | 0.10 |
| Cotton + Garbanzo | 0.03 | 0.3 | 0.07 | 0.20 |
| Cotton + Velvetleaf + Garbanzo | 0.00 | 0.0 | 0.32 | 0.10 |
| Larvae on DOY 191 | | | | |
| Cotton | 0.00 | 0.00 | 0.00 | 0.00 b |
| Cotton + Velvetleaf | 0.25 | 0.00 | 0.12 | 0.05 b |
| Cotton + Garbanzo | 0.10 | 0.00 | 0.00 | 0.05 b |
| Cotton + Velvetleaf + Garbanzo | 0.18 | 0.02 | 0.07 | 5.00 a |

| | (Seed cotton (pounds |
|---|---|
| | per acre) on DOY 261) |
| Cotton | 728.0 ab |
| Cotton + Velvetleaf | 413.1 b |
| Cotton + Garbanzo | 947.9 a |
| Cotton + Velvetleaf + Garbanzo | 673.9 ab |

^{a}TBW = tobacco budworm, BAW = beet armyworrn, SMC = saltmarsh caterpillar, CL = cabbage looper. Means in columns in each DOY followed by different letters are significantly different at α = 0.05.

### EXAMPLE 2

### Cotton Interplanted with Garbanzo Beans

Test 4. In 2001 in another research area, located on the Texas A&M University farm close to College Station, Texas, 40 rows of cotton (variety DP436RR, 40″ centers and 750 feet in length) were planted on 3 different dates and seeded with garbanzo beans at planting, with the same undetermined variety of Tests 2 and 3, on rows 13, 14, 27 and 28, achieving a final cotton plant density of 1.29, 2.25, and 2.21 plants per row-foot for the early (seeded on DOY 106), intermediate (DOY 134), and late planting (DOY 149), respectively. The terms “early”, “intermediate” and “late” will be used to refer to these plantings later in the text. The garbanzo bean plant density when the evaluations started (DOY 194), coinciding with high tobacco budworm oviposition, was 0.3, 1.38, and 0.78 plants per row-foot for early, intermediate and late planting, respectively.

Evaluations to asses “the garbanzo and cotton developmental effect” in this test were made by removing 10 cotton plants on each of the rows 13, 14, 27, and 28 (interplanted with garbanzo) and 10 plants on each of the rows 6, 7, 34, and 35 (pure stand cotton) for each planting. Plants were inspected for insect presence and damage as well as phenological stage. Yields of the rows described above were obtained by hand harvesting. Data were analyzed by analysis of variance and when F-values were significant (P<0.05), means were separated performing a Tukey's test (a=0.05).

Determining the effect of garbanzo beans interplanted with cotton for enhancing lepidopterous pests on cotton research plots was the main objective of this test. On the 3 different developmental stages of cotton, tobacco budworm presence on garbanzo plants was very high (data not included). No differences were found on insect oviposition or presence of larvae on cotton plants (Table 4). Some differences were found between planting dates but not between interplanted and monoculture. A partial explanation of this can be that the density of garbanzo bean plants of some of the planting dates (early and late) was lower than the density of Tests 2 and 3; therefore, attraction of the tobacco budworm could be directly related to the density of garbanzo bean plants in the field.

TABLE 4
Average number of tobacco budworm (Heliothis virescens) and
damage per cotton plant planted at three different dates with
and without garbanzo plants.

| | | | |
|---|---|---|---|
| Damaged | Eggs | squares | larvae |

Evaluation on DOY 194

| | | | |
|---|---|---|---|
| Late cotton | 0.53 ab | 1.22 b | 0.00 |
| Late cotton + garbanzo | 0.48 ab | 4.37 a | 0.13 |
| Intermediate cotton | 0.58 a | 3.46 ab | 0.05 |
| Intermediate cotton + garbanzo | 0.18 ab | 4.82 a | 0.18 |
| Early cotton | 0.08 b | 3.14 ab | 0.10 |
| Early cotton + garbanzo | 0.23 ab | 2.50 ab | 0.05 |
| Evaluation on DOY 208 | | | |
| Late cotton | 1.03 | NA | 0.25 |
| Late cotton + garbanzo | 1.30 | NA | 0.18 |
| Intermediate cotton | 0.88 | NA | 0.20 |
| Intermediate cotton + garbanzo | 1.00 | NA | 0.50 |
| Early cotton | 0.63 | NA | 0.30 |
| Early cotton + garbanzo | 0.98 | NA | 0.20 |

| | Pounds of seed cotton per acre |
|---|---|
| Late cotton | 1,505 bc |
| Late cotton + garbanzo | 1,468 bc |
| Intermediate cotton | 1,341 c |
| Intermediate cotton + garbanzo | 1,649 b |
| Early cotton | 2,040 a |
| Early cotton + garbanzo | 1,947 a |

Means in columns in each DOY followed by different letters are significantly different at α = 0.05.

In summary, Velvetleaf (Abutilon theophrasti Medikus) and/or garbanzo beans (Cicer arietinum L.) plants were interplanted into cotton with the aim of attracting more lepidopterous pests into research plots. The use of velvetleaf proved to be effective in obtaining more Heliothis virescens (F.) and Trichoplusia ni (Hübner) pressure on cotton plants but since pests such as whiteflies and bugs were more abundant on these plants, there is a potential detrimental effect of attracting undesirable insects to experimental trials. Garbanzo beans attracted high numbers of Heliothis virescens and Spodoptera exigua (Hübner) and low numbers of Trichoplusia ni. Experimental cotton plots interplanted with velvetleaf and garbanzo beans attracted the whole worm spectrum described before, while not lowering yields when compared to cotton alone, but still had the potential of creating a good environment for undesirable insect species. Cotton interplanted with garbanzo beans appears to be the best of these methods for increasing larval pressure in research plots because it attracts high numbers and diverse species of Lepidoptera, but it does not lower seed cotton production.

The principles, preferred embodiments and modes of operation of the present invention have been described in the foregoing specification and examples. The invention which is intended to be protected herein, however, is not to be construed as limited to the particular forms disclosed, since they are to be regarded as illustrative rather than restrictive. Variations and changes may be made by those skilled in the art without departing from the spirit of the invention.

### BIBLIOGRAPHY

Blanco, Carlos, Jan. 11, 2002, Interplanting of alternative host plants for enhancing Lepidoptera in cotton. 2002 Beltwide Cotton Conference Proceedings.

Headrick, D. H., T. S. Bellows, Jr., and T. M. Perring. 1997. Behavior of female Eretmocerus sp. Nr. Californicus Howard (Apheliniidae: Hymenoptera) attacking Bemisia argentifolii Bellows and Perring (Aleyrodidae: Homoptera) on two native Californian weeds. The Canadian Entomologist 129: 335-345.

Hendricks, D. E. 1992. The role of velvetleaf growing in or near cotton fields as a host for the tobacco budworms and bollworms in the Mississippi River delta. Southwestern Entomologist 17: 199-207.

Patterson, D. T., R. D. Coffin, and N. R. Spencer. 1987. Effects of temperature on damage to velvetleaf (Abutilon theophrasti) by the scentless plant bug Niesthrea louisianica. Weed Science 35: 324-327.

Ramnath, S., Chitra, K., and Uthamasamy, S. 1992. Behavioral response of Helicoverpa armigera (Hub.) to certain host plants. Journal of Insect Science 5: 147-149.

Reed, W., S. S. Lateef, and S. Sithanantham. 1980. Insect pest management on chickpea. Proceedings of the International Workshop on Chickpea Improvement, 28 Feb.-2 Mar. 1979. International Crops Research Institute for the Semi-Arid Tropics, Patancheru, Andhra Pradesh, India: 1980. p. 179-183.

Schneider, J. C., R. T. Roush, W. F. Kitten, and M. L. Laster. 1989. Movement of Heliothis virescens (Lepidoptera: Noctuidae) in Mississippi in the spring: implications for area-wide management. Environmental Entomology 18: 438-446.

Shaver, T. N., and J. D. Lopez Jr. 1996. Ovipositional response of the tobacco budworm and bollworm to chickpea. Southwestern Entomologist 21: 277-282.

Spencer, N. R. 1988. Inundative biological control of velvetleaf, Abutilon theophrasti (Malvaceae) with Niesthrea louisianica (Hem.: Rhopalidae). Entomophaga 33: 421-429.

We claim:

1. A method for creating refugia near a transgenic Bacillus thuringiensis (Bt) crop comprising interplanting plants chosen from the group consisting of Abutilon and Cicer.

2. The method of claim 1 wherein the plants are Cicer arietinum L and Abutilon theophasti.

3. The method of claim 1 wherein the plants are chosen from the group consisting of species within the genus Cicer.

4. The method of claim 3 wherein the plants are Cicer arietinum L.
